(19) United States
(12) Patent Application Publication
(10) Pub. No.: US 2026/0171296 A1
(43) Pub. Date: Jun. 18, 2026

(54) REACTOR

(71) Applicant: TOYOTA JIDOSHA KABUSHIKI KAISHA, Toyota-shi (JP)

(72) Inventor: Yoshihide FUKUDA, Toyota-shi (JP)

(73) Assignee: TOYOTA JIDOSHA KABUSHIKI KAISHA, Toyota-shi (JP)

(21) Appl. No.: 19/369,273

(22) Filed: Oct. 26, 2025

(30) Foreign Application Priority Data
Dec. 17, 2024 (JP) 2024-221144

(51) Int. Cl. H01F 27/28; H01F 27/24; H01F 27/40

(52) U.S. Cl. CPC H01F 27/28; H01F 27/24; H01F 27/40

(57) ABSTRACT

Annular core, a substrate on which a plurality of conductor patterns are formed, is formed in a substantially U-shape, and is bonded to the substrate in a state of being arranged so as to straddle the core, a plurality of conductive members arranged side by side in the extending direction of the core, comprising, the conductive member is connected to the end of the conductor pattern at the junction portion of the substrate, the conductor pattern, electrically connecting the conductive members adjacent in the extending direction, a plurality of conductor patterns and a plurality of conductive members are arranged so as to surround the core, are connected in a coil shape.

### CROSS-REFERENCE TO RELATED APPLICATION

This application claims priority to Japanese Patent Application No. 2024-221144 filed on December 17, 2024. The disclosure of the above-identified application, including the specification, drawings, and claims, is incorporated by reference herein in its entirety.

### BACKGROUND

### 1. Technical Field

The present disclosure relates to a reactor.

### 2. Description of Related Art

Japanese Unexamined Patent Application Publication No. 2017-034012 (JP 2017-034012 A) discloses the structure of a reactor in which a winding is wound around a core, in which an end portion of the winding is joined to a substrate to integrate the reactor and the substrate.

### SUMMARY

The manufacture of the configuration described in JP 2017-034012 A involves a step of winding a winding around a core and a step of assembling a reactor to a substrate after winding the winding around the core. The step of winding a winding around a core is complicated, and requires a high manufacturing cost.

The present disclosure has been made in view of the above circumstances, and an object of the present disclosure is to provide a reactor capable of reducing a manufacturing cost while simplifying a structure with a structure that does not include a winding.

A first aspect of the present disclosure provides a reactor including: an annular core; a substrate on which a plurality of conductor patterns is provided; and a plurality of conductive members shaped in a substantially U-shape, joined to the substrate in a state of being disposed so as to straddle the core, and disposed side by side in an extending direction of the core, in which: the conductive members are connected to an end of the conductor patterns at a joint portion with the substrate; the conductor patterns electrically connect the conductive members adjacent to each other in the extending direction; and the conductor patterns and the conductive members are disposed so as to surround the core, and connected in a coil shape.

According to the present disclosure, it is possible to reduce the manufacturing cost while simplifying a structure with a structure that does not include a winding.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating a reactor according to a first embodiment;

FIG. 2 is a diagram for explaining a structure of a reactor according to the first embodiment;

FIG. 3 is a diagram for explaining a conductor pattern;

FIG. 4 is a diagram for explaining a detailed structure of a copper plate and a conductor pattern;

FIG. 5 is a diagram schematically showing a reactor according to a first modification of the first embodiment;

FIG. 6 is a diagram schematically showing a reactor according to a second modification of the first embodiment;

FIG. 7 is a diagram illustrating a reactor according to the second embodiment;

FIG. 8 is a diagram for explaining a detailed structure of a bypass circuit and a semiconductor switch;

FIG. 9 is a diagram illustrating a reactor according to a third embodiment;

FIG. 10 is a diagram for explaining a detailed structure of the reactor according to the third embodiment;

FIG. 11 is a view for explaining the detailed configuration of the first copper plate, the second copper plate, the first conductor pattern, and the second conductor pattern; and

FIG. 12 is a diagram illustrating a reactor according to a modification of the third embodiment.

### DETAILED DESCRIPTION OF EMBODIMENTS

Hereinafter, a reactor according to an embodiment of the present disclosure will be described in detail. The present disclosure is not limited to the embodiments described below.

### First Embodiment

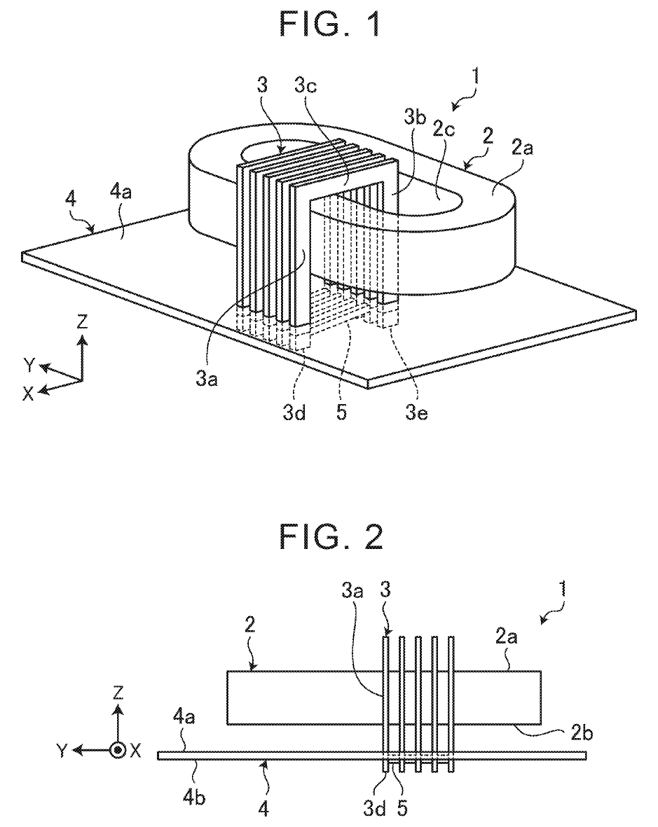

FIG. 1 is a diagram schematically illustrating a reactor according to a first embodiment. The reactor 1 is a reactor that does not include a winding. The reactor 1 includes a core 2, a plurality of copper plates 3, and a substrate 4. The reactor 1 has a structure in which the copper plate 3 and the substrate 4 are integrated. The substrate 4 is provided with a plurality of conductor patterns 5. The plurality of copper plates 3 and the plurality of conductor patterns 5 are arranged so as to surround the core 2, and are connected in a coil shape. The reactor 1 is mounted on a vehicle.

The core 2 is an annular core made of a magnetic material and is formed in a flat cylindrical shape. When the core 2 is viewed from the Z direction, the core 2 has a straight portion extending in a straight line and a curved portion extending in a curved line. The core 2 is disposed at a position facing the mounting surface 4a of the substrate 4. The core 2 and the substrate 4 are spaced apart from each other in the Z direction, and an insulating member (not shown) is interposed between the core 2 and the substrate 4. The core 2 is supported by the substrate 4 via an insulating member. For example, an insulating member made of a gel-like member is interposed between the core 2 and the mounting surface 4a. As shown in FIGS. 1 and 2, the core 2 has a first end surface 2a that is an end surface on one side in the Z direction, a second end surface 2b that is an end surface on the other side in the Z direction, and a through-hole 2c that penetrates in the Z direction. The second end surface 2b faces the mounting surface 4a.

The copper plate 3 is a conductive member formed in a substantially U-shape. The copper plate 3 is bonded to the substrate 4 in a state of being arranged so as to straddle the core 2, and a plurality of copper plates are arranged side by side in the extending direction of the core 2. In the first embodiment, five copper plates 3 are arranged at predetermined intervals in the extending direction of the core 2. The copper plate 3 is a flat plate provided perpendicularly to the mounting surface 4a, and is arranged with a thickness direction in the Y direction, a width direction in the X direction, and a height direction in the Z direction. In some cases, one side in the Z direction is referred to as an upper side, and the other side in the Z direction is referred to as a lower side.

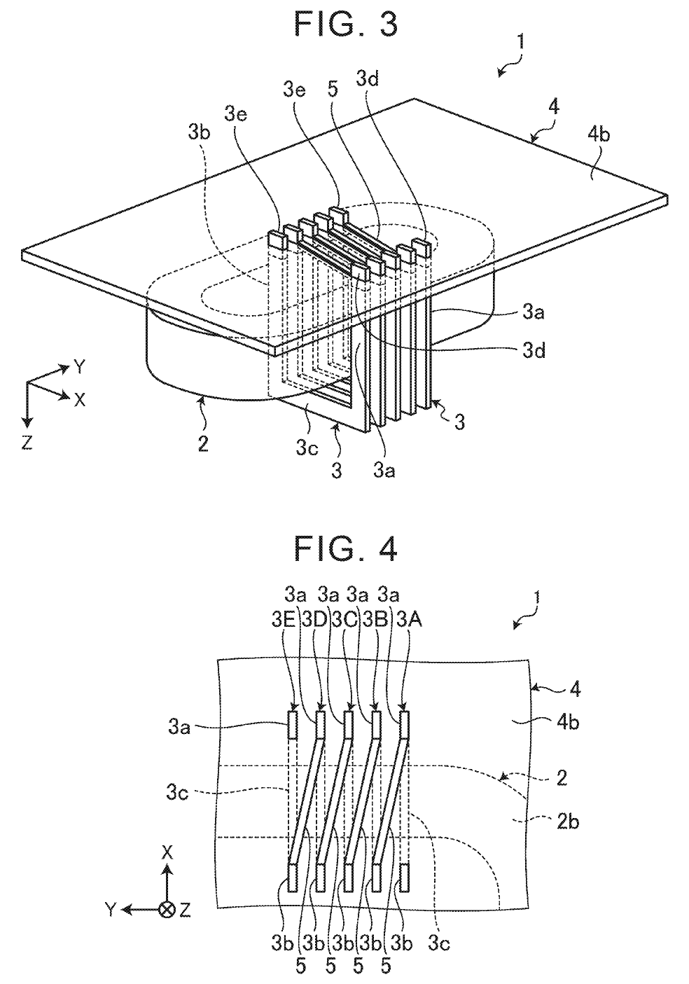

The copper plate 3 has a first leg portion 3a, a second leg portion 3b, and an intermediate portion 3c. The first leg portions 3a are disposed on the outer periphery of the core 2, and the end portions 3d are bonded to the substrate 4. The second leg portion 3b is disposed on the inner periphery of the core 2, and the end portion 3e is joined to the substrate 4 while being inserted through the through-hole 2c of the core 2. The first leg portion 3a and the second leg portion 3b extend in the Z-direction, and the end portion 3d of the first leg portion 3a and the end portion 3e of the second leg portion 3b pass through the substrate 4. The intermediate portion 3c is a part connecting the first leg portion 3a and the second leg portion 3b. The copper plate 3 has a pair of leg portions connected via an intermediate portion 3c. The intermediate portion 3c is disposed above the first end surface 2a of the core 2 and extends in the X-direction. Each of the first leg portion 3a, the second leg portion 3b, and the intermediate portion 3c is formed in a straight line. As shown in FIGS. 2 and 3, the copper plate 3 is connected to an end portion of the conductor pattern 5 at a joint portion with the substrate 4.

The substrate 4 is a printed circuit board on which a plurality of conductor patterns 5 are formed. In the reactor 1, a conductor pattern 5 that carries a part of the coil is provided in the substrate 4. Reactor 1 is configured to obtain the same effect as the winding by electrically connecting the conductor pattern 5 and the copper plate 3. The substrate 4 has a through-hole serving as a joint portion with the copper plate 3. The through hole of the substrate 4 penetrates in the thickness direction of the substrate 4, and is a hole through which the leg portion of the copper plate 3 is inserted. The through hole is formed in accordance with the shape of the leg portion of the copper plate 3, and includes a first through hole through which the first leg portion 3a is inserted, and a second through hole through which the second leg portion 3b is inserted. On the substrate 4, a plurality of first through holes and a plurality of second through holes are arranged side by side in the Y direction at different positions in the X direction. Among the plurality of through-holes, the first through-hole and the second through-hole for joining the same copper plate 3 are provided at the same position in the Y direction and at a position apart in the X direction. These through holes serve as portions where the copper plate 3 and the substrate 4 are joined to each other, and also serve as portions where the copper plate 3 and the conductor pattern 5 are connected to each other. The copper plate 3 is connected to an end portion of the conductor pattern 5 at a joint portion with the substrate 4. The first leg portions 3a are soldered or welded to the conductor patterns 5 while being inserted through the first through holes. The second leg portions 3b are soldered or welded to the conductor patterns 5 while being inserted through the second through holes.

The conductor pattern 5 is a coil pattern provided on the substrate 4. On the substrate 4, a plurality of conductor patterns 5 are formed side by side in the extending direction of the core 2. The number of the conductor patterns 5 corresponds to the number of the copper plates 3. As shown in FIGS. 2 and 3, a part of the conductor pattern 5 is provided inside the substrate 4, and the remaining part protrudes toward the mounting surface 4b. The mounting surface 4b is a surface facing away from the mounting surface 4a. The substrate 4 includes a layer on which the conductor pattern 5 is formed and a layer on which the conductor pattern 5 is not formed. Both ends of the conductor pattern 5 are connected to different copper plates 3. In the first embodiment, the conductor pattern 5 electrically connects the copper plates 3 adjacent to each other in the extending direction of the core 2. The reactor 1 includes a current circuit in which the copper plate 3 and the conductor pattern 5 are alternately connected. In the reactor 1, by alternately connecting the conductor pattern 5 on the substrate 4 side and the copper plate 3 arranged so as to straddle the core 2, a coil-shaped conductor arranged so as to surround the core 2 is formed.

As shown in FIG. 4, from one side in the Y-direction, the copper plate 3A, copper plate 3B, copper plate 3C, copper plate 3D, copper plate 3E are arranged in this order, and are arranged in the order of the conductor pattern 5A, conductor pattern 5B, conductor pattern 5C, conductor pattern 5D. The copper plate 3A and the copper plate 3B adjacent to each other are electrically connected to each other via the conductor patterns 5A. Both ends of the conductor pattern 5A are connected to the first leg portion 3a of the copper plate 3A and the second leg portion 3b of the copper plate 3B. The copper plate 3B and the copper plate 3C adjacent to each other are electrically connected to each other via the conductor patterns 5B. Both ends of the conductor pattern 5B are connected to the first leg portion 3a of the copper plate 3B and the second leg portion 3b of the copper plate 3C. The copper plate 3C and the copper plate 3D adjacent to each other are electrically connected to each other via the conductor patterns 5C. Both ends of the conductor pattern 5C are connected to the first leg portion 3a of the copper plate 3C and the second leg portion 3b of the copper plate 3D. The copper plate 3D and the copper plate 3E adjacent to each other are electrically connected to each other via the conductor patterns 5D. Both ends of the conductor pattern 5D are connected to the first leg portion 3a of the copper plate 3D and the second leg portion 3b of the copper plate 3E. When a current is inputted from the second leg portion 32b of the copper plate 3A, a current flows from the first leg portion 3a of the copper plate 3A to the second leg portion 3b of the copper plate 3B via the conductor pattern 5A. Thereafter, in the same manner, the current flows in the order of the copper plate 3B, the conductor pattern 5B, the copper plate 3C, the conductor pattern 5C, the copper plate 3D, the conductor pattern 5D, and the copper plate 3E, and is outputted from the first leg portion 3a of the copper plate 3E.

On the substrate 4, there is a projection area in which the core 2 is projected in the Z direction. The projected area is not limited to the mounting surface 4a but includes the inside of the substrate 4. When the substrate 4 is viewed from the Z direction, there is a projection region having the same shape as that of the core 2, and the shape of the projection region is a flat shape. Since the through hole of the substrate 4 is provided outside the projection area, the copper plate 3 and the end portion of the conductor pattern 5 are connected outside the projection area. The conductor pattern 5 extends across the projection area and is connected to one of the positive electrode side leg portions and the other of the negative electrode side leg portions of the adjacent copper plates 3. When the first leg portion 3a is a positive electrode side leg portion and the second leg portion 3b is a negative electrode side leg portion, only the negative electrode side leg portion is disposed on one outer side with respect to the projected area, and only the positive electrode side leg portion is disposed on the other outer side.

As described above, according to the first embodiment, since the copper plate 3 and the substrate 4 are integrated, it is not necessary to wind the wire to the core 2, it is possible to simplify the structure with a structure that does not include a winding. When the reactor 1 is manufactured, since the process of winding the winding wire around the core 2 is unnecessary, the manufacturing cost can be reduced. Since the conductor pattern 5 to be a part of the coil is printed directly on the substrate 4, it is possible to reduce the size and weight of the reactor 1.

Note that the conductor pattern 5 is not limited to a structure in which a part of the conductor pattern is provided inside the substrate 4. The entire conductor pattern 5 may be provided inside the substrate 4. Alternatively, the entire conductor pattern 5 may be provided only on the mounting surface 4a or the mounting surface 4b.

The shape of the core 2 is not particularly limited. The core 2 may have a circular shape or a square shape.

The number of the copper plates 3 and the portion where the copper plates 3 straddle the core 2 are not particularly limited. The copper plate 3 is not limited to the straight portion of the core 2, and may be disposed so as to straddle the curved portion.

The reactor 1 may be provided with a metal conductor instead of the copper plate 3. Metal conductors are U-shaped or portal-shaped.

### Modification of the first embodiment

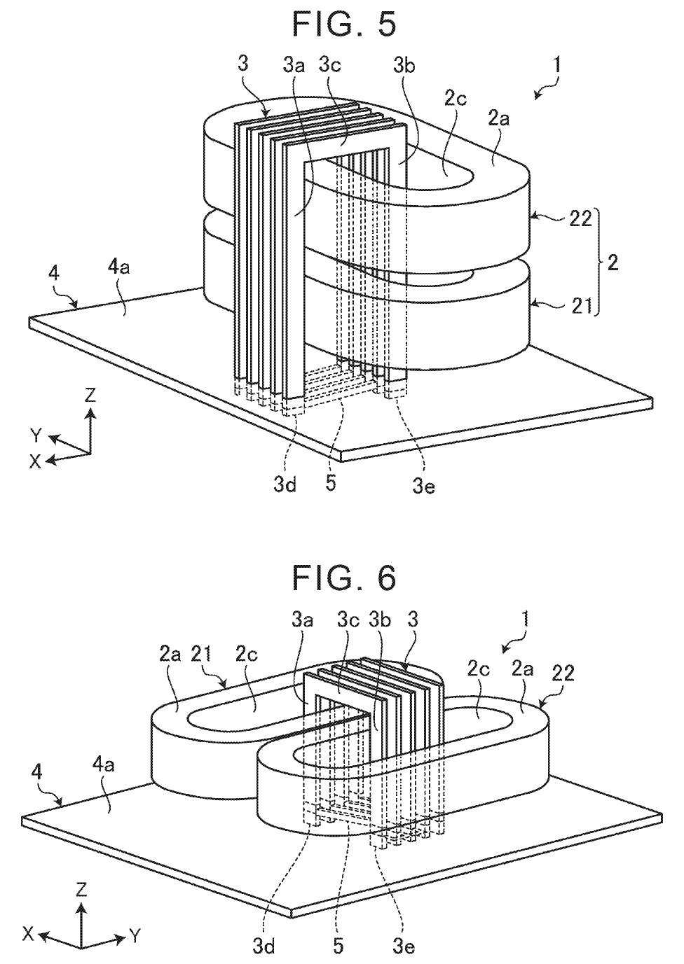

In a variant of the first embodiment, the reactor 1 comprises a plurality of cores 2. The reactor 1 may have a structure in which two cores 2 as shown in FIG. 5 are stacked in the Z direction, and may have a structure in which two cores 2 as shown in FIG. 6 are arranged in the X direction.

As shown in FIG. 5, the reactor 1 in the first modification of the first embodiment includes a first core 21 and a second core 22 opposed to the first core 21 in the Z direction. Each of the first core 21 and the second core 22 is disposed on the same mounting surface 4a, and is formed in the same configuration. Copper plate 3 is arranged so as to straddle both the first core 21 and the second core 22, and is arranged in a plurality in the extending direction of the first core 21 and the extending direction of the second core 22. The first core 21 is configured similarly to the core 2. The second core 22 is disposed to face the first end surface of the first core 21, and is spaced apart from the first core 21 in the Z direction. An insulating member (not shown) is interposed between the second end surface of the first core 21 and the first end surface of the first core 21. The second core 22 is supported by the first core 21 via an insulating member. The copper plate 3 and the conductor pattern 5 form a coil-shaped conductor arranged so as to surround both the first core 21 and the second core 22 arranged in the Z direction. The conductor pattern 5 extends across both the projection area of the first core 21 and the projection area of the second core 22. In the first modification, the projection area of the first core 21 and the projection area of the second core 22 coincide with each other. In the example shown in FIG. 5, the copper plate 3 is disposed in the straight portion of the first core 21 and the straight portion of the second core 22, in the first modification, the curved portion of the first core 21 and the curved portion of the second core 22 copper plate 3 may be disposed.

As shown in FIG. 6, the reactor 1 in the second modification of the first embodiment includes a first core 21 and a second core 22 arranged side by side with the first core 21 in the X direction. In the second modification, the straight portion of the first core 21 and the straight portion of the second core 22 are disposed to face each other in the X direction. The straight portion of the first core 21 and the straight portion of the second core 22 are arranged so as to be parallel to the Y direction, and are arranged at the same position in the Y direction. The second core 22 is disposed at a position facing the mounting surface 4a, and is spaced apart from the substrate 4 in the Z-direction. An insulating member (not shown) is interposed between the second end surface of the second core 22 and the mounting surface 4a of the substrate 4. The second core 22 is supported by the substrate 4 via an insulating member. Copper plate 3 is arranged so as to straddle both the first core 21 and the second core 22 aligned in the X direction, the extending direction of the first core 21 and the second core 22 are arranged side by side in the extending direction. The end portion 3d of the first leg portion 3a is joined to the substrate 4 while being inserted through the through-hole 2c of the first core 21. The end portion 3e of the second leg portion 3b is joined to the substrate 4 while being inserted through the through-hole 2c of the second core 22. The intermediate portion 3c is disposed above the first end surface 2a of the first core 21 and the first end surface 2a of the second core 22, and is disposed so as to straddle both the straight portion of the first core 21 and the straight portion of the second core 22. The plurality of copper plates 3 and the plurality of conductor patterns 5 are arranged so as to surround both the first core 21 and the second core 22 arranged in the X direction, and are connected in a coil shape. In the second modification, the projection area of the first core 21 and the projection area of the second core 22 are different from each other.

### Second embodiment

In the second embodiment, the semiconductor switch and the bypass circuit are mounted on the conductor pattern 5 incorporated in the substrate 4, and the inductance value and the coil resistance value are optimized according to the requirements. Note that description of the same configuration as in the first embodiment will be omitted, and reference numerals thereof will be referred to.

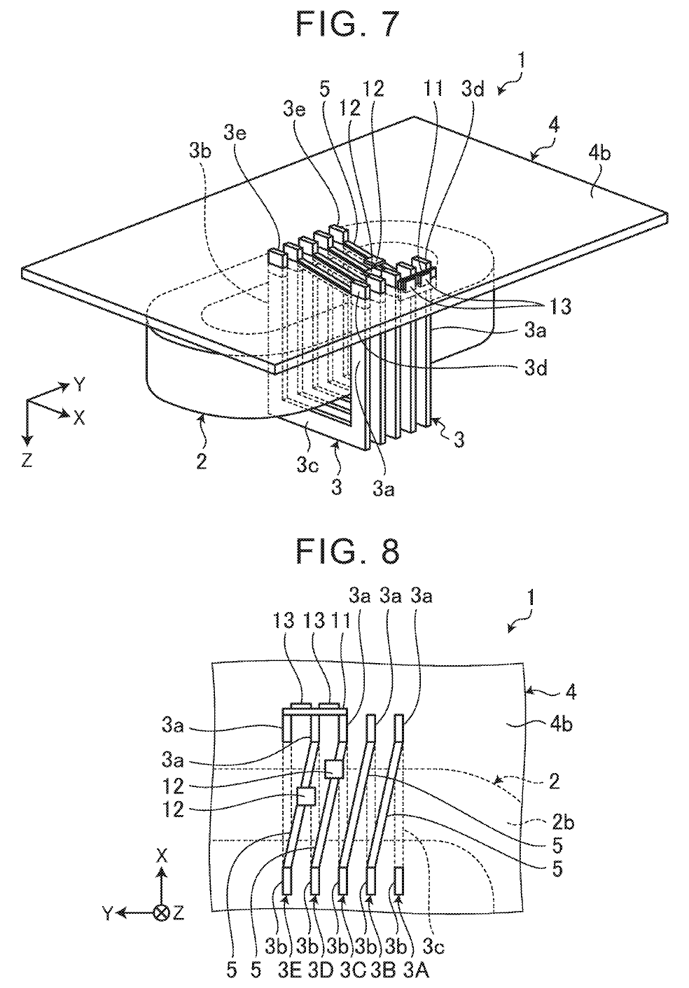

As shown in FIG. 7, the reactor 1 of the second embodiment includes a bypass circuit 11, a first semiconductor switch 12, and a second semiconductor switch 13. The bypass circuit 11, the first semiconductor switch 12, and the second semiconductor switch 13 are both provided on the substrate 4.

The bypass circuit 11 is a circuit that bypasses a part of a current circuit including the copper plate 3 and the conductor pattern 5. The bypass circuit 11 is for changing the number of turns of the coil in the current circuit. As shown in FIG. 8, the bypass circuit 11 is connected to the first leg portion 3a of the copper plate 3C, the first leg portion 3a of the copper plate 3D, and the first leg portion 3a of the copper plate 3E. The bypass circuit 11 connects the first leg portions 3a of the copper plates 3 adjacent to each other.

The first semiconductor switch 12 is a semiconductor switch connected to the conductor pattern 5, and switches between conduction and interruption of the conductor pattern 5. When the first semiconductor switch 12 is turned on, the connected conductor pattern 5 becomes conductive. When the first semiconductor switch 12 is turned off, the connected conductor pattern 5 becomes non-conductive.

The second semiconductor switch 13 is a semiconductor switch connected to the bypass circuit 11, and switches between conduction and interruption of the bypass circuit 11. When the second semiconductor switch 13 is turned on, the connected bypass circuit 11 becomes conductive. When the second semiconductor switch 13 is turned off, the connected bypass circuit 11 becomes non-conductive.

The reactor 1 switches the conduction path including the copper plate 3 and the conductor pattern 5 by the bypass circuit 11 and the first and second semiconductor switches 12 and 13. Thus, the reactor 1 can change the number of the copper plates 3 and the number of the conductor patterns 5 included in the conduction path. In the reactor 1, the first semiconductor switch 12 and the second semiconductor switch 13 are switched as necessary to adjust the number of coil turns.

As shown in FIG. 8, the bypass circuit 11 and the second semiconductor switch 13 are mounted on the substrate 4 by a vertical arrangement. Both the bypass circuit 11 and the second semiconductor switch 13 are arranged perpendicularly to the mounting surface 4a, 4b, and at least a part thereof is provided inside the substrate 4. Both the bypass circuit 11 and the second semiconductor switch 13 are partially provided inside the substrate 4, and the remaining portions protrude toward the mounting surface 4b. As a comparative example, when the bypass circuit and the second semiconductor switch are mounted on the substrate by a planar arrangement along XY plane, a large mounting area of the substrate must be secured in order to arrange the bypass circuit and the second semiconductor switch in XY plane. On the other hand, in the second embodiment, since the bypass circuit 11 and the second semiconductor switch 13 are vertically arranged, the mounting area of the substrate 4 can be reduced as compared with the comparative example.

According to the second embodiment, by switching the conduction path of the current circuit by the bypass circuit 11 and the first and second semiconductor switches 12 and 13, it is possible to adjust the number of coil turns in the coil-shaped conductor. As a result, the length of the conductive path can be shortened as necessary, and loss due to energization can be reduced. The effect of reducing the magnetic loss due to the optimization of the inductance is obtained. By vertically arranging the bypass circuit 11 and the second semiconductor switch 13, the area of the mounting surface 4a, 4b can be reduced, and the reactor 1 can be miniaturized.

### Third embodiment

The third embodiment is a reactor 1 comprising two cores arranged on both sides of the substrate 4, the direction of the current is arranged alternately on the substrate 4 coil-shaped conductors, the direction of the current in each coil-shaped conductor It is configured to cancel the magnetic flux by changing. Note that description of the same configuration as in the first embodiment will be omitted, and reference numerals thereof will be referred to.

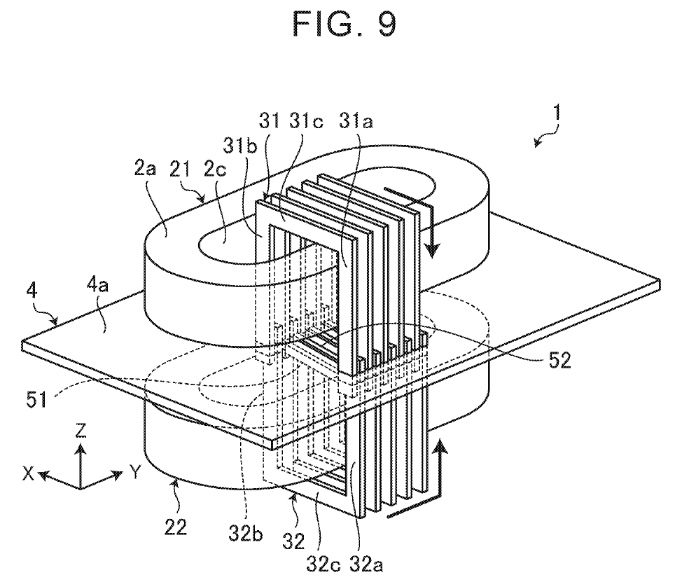

As shown in FIG. 9, the reactor 1 of the third embodiment includes a first core 21, a second core 22, a plurality of first copper plates 31, a plurality of second copper plates 32, a plurality of first conductor patterns 51, and a plurality of second conductor patterns 52.

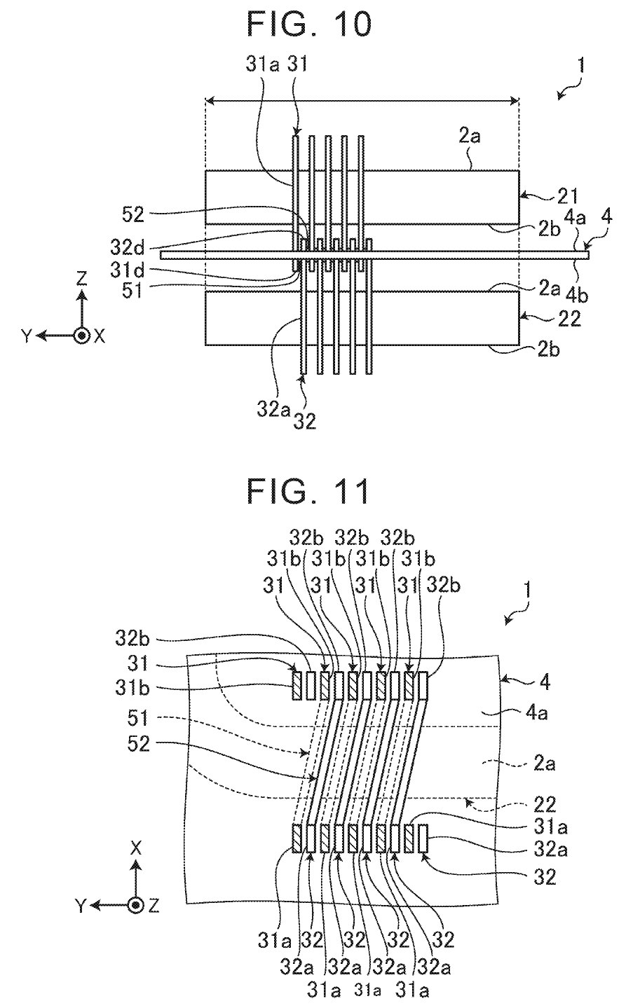

As shown in FIG. 10, the first core 21 is disposed on the mounting surface 4a of the substrate 4. The second core 2B is disposed on the mounting surface 4b of the substrate 4, and the first end surface 2a faces the mounting surface 4b of the substrate 4. Each of the first core 21 and the second core 22 has a straight portion and is formed in the same shape. The reactor 1 including the first core 21 and the second core 22 can be implemented with a projected area of one core. The second core 22 is spaced apart from the substrate 4 in the Z direction. The second core 22 is supported by the substrate 4 via an insulating member. An insulating member is interposed between the first end surface 2a of the second core 22 and the mounting surface 4b.

The first copper plate 31 and the second copper plate 32 are formed in the same shape. The first copper plate 31 is arranged so as to straddle the straight portion of the first core 21 on the mounting surface 4a, and is arranged side by side in the extending direction of the first core 21. The first copper plate 31 has a first leg portion 31a, a second leg portion 31b, and an intermediate portion 31c. The second copper plate 32 is arranged so as to straddle the straight portion of the second core 22 on the mounting surface 4b, and is arranged side by side in the extending direction of the second core 22. The second copper plate 32 has a first leg portion 32a, a second leg portion 32b, and an intermediate portion 32c. The intermediate portion 32c is disposed below the second end surface 2b of the second core 22. As shown in FIG. 11, the first leg portions 31a and the first leg portions 32a are alternately arranged in the Y-direction and are bonded to the substrate 4. The second leg portions 31b and the second leg portions 32b are alternately arranged in the Y-direction and are bonded to the substrate 4. The first copper plate 31 is connected to an end portion of the first conductor pattern 51 at a joint portion with the substrate 4. The second copper plate 32 is connected to an end portion of the second conductor pattern 52 at a joint portion with the substrate 4.

The first conductor pattern 51 and the second conductor pattern 52 are arranged alternately in the extending direction of the first core 21 and the extending direction of the second core 22. The first conductor pattern 51 electrically connects the first copper plates 31 arranged across the second copper plate 32 among the plurality of first copper plates 31 arranged side by side in the extending direction of the first core 21. The first conductor pattern 51 connects the first copper plate 31 disposed on both sides with the second copper plate 32 interposed therebetween to one of the first leg portions 31a and the other of the second leg portions 31b. The second conductor pattern 52 electrically connects the second copper plates 32 arranged across the first copper plate 31 among the plurality of second copper plates 32 arranged side by side in the extending direction of the second core 22. The second conductor pattern 52 is connected to the first leg portion 32a on one side and the second leg portion 32b on the other side with respect to the second copper plate 32 disposed on both sides with the first copper plate 31 interposed therebetween.

The conductor in which the first conductor pattern 51 and the first copper plate 31 are connected forms a coil-shaped conductor arranged so as to surround the first core 21. The conductor in which the second conductor pattern 52 and the second copper plate 32 are connected forms a coil-shaped conductor arranged so as to surround the second core 22.

In FIG. 9, the direction of the current flowing through the coiled conductor is indicated by an arrow. The direction of the current flowing through the coil-shaped conductor formed by the first conductor pattern 51 and the first copper plate 31, and the direction of the current flowing through the coil-shaped conductor formed by the second conductor pattern 52 and the second copper plate 32 is a direction to cancel the magnetic flux of each other. When the reactor 1 is viewed from the Y direction, a current flows clockwise in a coil-shaped conductor including the first conductor pattern 51 and the first copper plate 31, and a current flows counterclockwise in a coil-shaped conductor including the second conductor pattern 52 and the second copper plate 32. In the third embodiment, the magnetic flux is cancelled by alternately arranging two coil-shaped conductors having different current directions and changing the current direction.

According to the third embodiment, it is possible to cancel the magnetic flux interlinking the substrate 4 and reduce noise. By mounting the two cores with the substrate 4 sandwiched therebetween, it is possible to mount with a projected area of one core. Accordingly, the substrate mounting area can be minimized, and the area of the mounting surface 4a, 4b of the substrate 4 can be reduced. Further, it contributes to downsizing of the vehicle on which the reactor 1 is mounted.

### Modification of the third embodiment

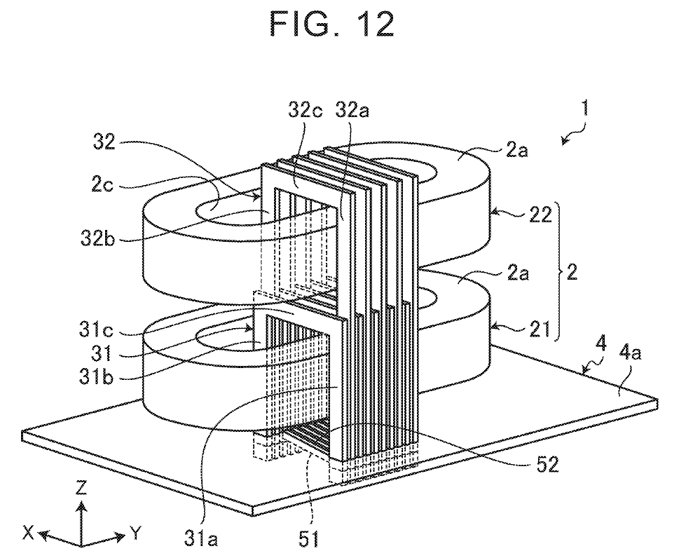

In a modification of the third embodiment, two cores are arranged on the same mounting surface side. As shown in FIG. 12, the reactor 1 may have a configuration in which two cores 2 are disposed on the mounting surface 4a and are stacked in the Z-direction.

What is claimed is:

1. A reactor comprising:
an annular core;
a substrate on which a plurality of conductor patterns is provided; and
a plurality of conductive members shaped in a substantially U-shape, joined to the substrate in a state of being disposed so as to straddle the core, and disposed side by side in an extending direction of the core, wherein:
the conductive members are connected to an end of the conductor patterns at a joint portion with the substrate;
the conductor patterns electrically connect the conductive members adjacent to each other in the extending direction; and
the conductor patterns and the conductive members are disposed so as to surround the core, and connected in a coil shape.

2. The reactor according to claim 1, further comprising:
a bypass circuit provided on the substrate to bypass the conductor patterns;
a first semiconductor switch provided on the substrate to switch between conduction and interruption of the conductor patterns; and
a second semiconductor switch provided on the substrate to switch between conduction and interruption of the bypass circuit, wherein:
the first semiconductor switch is connected to the conductor patterns;
the second semiconductor switch is connected to the bypass circuit; and
the first semiconductor switch and the second semiconductor switch switch a conduction path including the conductor patterns and the conductive members to change a number of the conductive members and a number of the conductor patterns included in the conduction path.

3. The reactor according to claim 2, wherein:
the bypass circuit is disposed perpendicularly to a mounting surface of the substrate, with at least a part of the bypass circuit provided inside the substrate; and
the second semiconductor switch is disposed perpendicularly to a mounting surface of the substrate, with at least a part of the second semiconductor switch provided inside the substrate.

4. The reactor according to claim 1, wherein:
the core includes
a first core disposed on one surface side of the substrate, and
a second core disposed side by side with the first core;
the conductive members are joined to the substrate in a state of being disposed so as to straddle both the first core and the second core, and disposed side by side in an extending direction of the first core and an extending direction of the second core; and
the conductor patterns and the conductive members are disposed so as to surround both the first core and the second core, and connected in a coil shape.

5. The reactor according to claim 1, wherein:
the core includes
a first core disposed on one surface side of the substrate, and
a second core disposed on the other surface side of the substrate;
the conductive members include
a plurality of first conductive members disposed on the one surface side of the substrate so as to straddle the first core, and disposed side by side in an extending direction of the first core, and
a plurality of second conductive members disposed on the other surface side of the substrate so as to straddle the second core, and disposed side by side in an extending direction of the second core;
the conductor patterns include
a plurality of first conductor patterns that electrically connects the first conductive members adjacent to each other in the extending direction of the first core, and
a plurality of second conductor patterns that electrically connects the second conductive members adjacent to each other in the extending direction of the second core;
the first conductor patterns and the second conductor patterns are disposed side by side alternately in the extending direction of the first core and the extending direction of the second core;
the first conductive members are connected to an end of the first conductor patterns at a joint portion with the substrate;
the second conductive members are connected to an end of the second conductor patterns at a joint portion with the substrate;
the first conductor patterns and the first conductive members are disposed so as to surround the first core, and connected in a coil shape;
the second conductor patterns and the second conductive members are disposed so as to surround the second core, and connected in a coil shape; and
a direction of a current that flows through a coil-shaped conductor constituted by the first conductor patterns and the first conductive members and a direction of a current that flows through a coil-shaped conductor constituted by the second conductor patterns and the second conductive members are determined so as to cancel out magnetic flux of each other.
